(19) United States
(12) Patent Application Publication
(10) Pub. No.: US 2021/0383425 A1
(43) Pub. Date: Dec. 9, 2021

(54) DEMAND SEGMENTATION AND FORECASTING FOR MEDIA INVENTORY ALLOCATION

(71) Applicant: Amobee, Inc., Redwood City, CA (US)

(72) Inventors: Mark Hrycay, Redwood City, CA (US); Carrie Ward, Redwood City, CA (US); Kevin Haley, Redwood City, CA (US); Kaushik Sinha, Redwood City, CA (US)

(73) Assignee: Amobee, Inc., Redwood City, CA (US)

(21) Appl. No.: 16/895,074

(22) Filed: Jun. 8, 2020

(51) Int. Cl. G06Q 30/02

(52) U.S. Cl. CPC G06Q 30/0244; G06Q 30/0264

(57) ABSTRACT

Forecasted attributes may be determined for scheduled media items based at least in part on observed characteristics associated with previously presented media items. A division of the scheduled media items into a plurality of media segments may be identified based on the forecasted attributes. A media allocation plan may be determined by solving an optimization problem that includes the media segments and the forecasted attributes.

### FIELD OF TECHNOLOGY

This patent document relates generally to data analytics and more specifically to media inventory analysis.

### BACKGROUND

People consume a variety of different media, such as websites, television broadcasts, radio, streaming audio, streaming video, and digital out-of-home (e.g., digital billboards) that is supported by advertisements. Effective advertisements are those that are more likely to engender a positive response in their viewers. Advertisement effectiveness may be increased by serving to viewers advertisements that are more accurately targeted to the viewers' needs and preferences. However, advertisement targeting involves a host of technical problems that render accurate targeting difficult. Accordingly, improved techniques for accurate and effective advertisement targeting are desired.

### OVERVIEW

According to various embodiments, techniques and mechanisms described herein facilitate the determination of a media allocation plan. In some implementations, a plurality of forecasted attributes may be determined. Each of the forecasted attributes may correspond to a respective one or more of a plurality of scheduled media items. Each of the forecasted attributes may be determined based at least in part on a plurality of observed characteristics associated with previously presented media items. A division of the scheduled media items may be divided into a plurality of media segments based on the forecasted attributes. Each media segment may include a respective one or more of the scheduled media items. A media allocation plan may be determined via processor by solving an optimization problem that includes the media segments and the forecasted attributes. The media allocation plan may identify an allocation of a plurality of advertisements to a subset of the media segments. The media allocation plan may be stored on a storage device.

In some implementations, the optimization problem may include one or more allocation constraint that each restrict the allocation of advertisements to the scheduled media items. A designated one of the allocation constraints may be a time constraint restricting presentation of a designated advertisement based on a time of day. Alternatively, or additionally, a designated one of the allocation constraints may be a device constraint restricting presentation of a designated one of the advertisements based on a type of device on which the designated advertisement is presented.

In some implementations, one or more of the forecasted attributes may correspond to a respective one or more of a plurality of advertising entities that each correspond to a respective one or more of the plurality of advertisements.

According to various embodiments, the optimization problem may be a linear programming problem or a mixed-integer programming problem.

In some implementations, the media allocation plan may include a respective media segment magnitude for each or selected ones of the subset of the media segments. The respective media segment magnitude may identify a number of advertisement opportunities associated with the respective media segment.

In some embodiments, the forecasted attributes include one or more attributes of a respective anticipated audience of the respective one or more scheduled media items. Alternatively, or additionally, the forecasted attributes may include one or more attributes of devices on which the scheduled media items are anticipated to be accessed. Alternatively, or additionally, the forecasted attributes may include one or more attributes of web pages on which the scheduled media items are anticipated to be accessed.

### BRIEF DESCRIPTION OF THE DRAWINGS

The included drawings are for illustrative purposes and serve only to provide examples of possible structures and operations for the disclosed inventive systems, apparatus, methods and computer program products for demand segmentation and forecasting for media inventory analysis. These drawings in no way limit any changes in form and detail that may be made by one skilled in the art without departing from the spirit and scope of the disclosed implementations.

FIG. 1 illustrates an example of an overview method for determining a media allocation plan, performed in accordance with one or more embodiments.

FIG. 2 illustrates an example of an arrangement of components in a demand segmentation and media allocation system, configured in accordance with one or more embodiments.

FIG. 3 illustrates an example of a method for determining an inventory segmentation, performed in accordance with one or more embodiments.

FIG. 4 illustrates a plot generated in accordance with one or more embodiments.

FIG. 5A, FIG. 5B, and FIG. 5C illustrate diagrams generated in accordance with one or more embodiments.

FIG. 6 illustrates a method for media inventory forecasting, performed in accordance with one or more embodiments.

FIG. 7 illustrates a diagram generated in accordance with one or more embodiments.

FIG. 8 illustrates an example of a computing device, configured in accordance with one or more embodiments.

FIG. 9 illustrates an example of a diagram generated in accordance with one or more embodiments.

FIG. 10 illustrates a plot generated in accordance with one or more embodiments.

FIG. 11 illustrates an example of a method for inventory allocation, performed in accordance with one or more embodiments.

### DETAILED DESCRIPTION

People consume a variety of different media supported by advertisements, such as websites, television broadcasts, radio, streaming audio, streaming video, and digital out-of-home (e.g., digital billboards). Effective advertisements are those that are more likely to engender a positive response in their viewers. Advertisement and spend effectiveness may be increased by serving to viewers advertisements that are more accurately targeted to the viewers' needs and preferences. For example, return on investment may be increased by reducing costs, increasing return, or some combination thereof. Determining a media allocation plan that represents an efficient allocation of media items based on an accurate forecasting of media item inventory attributes may help to manage reservations in constrained environments (e.g. linear TV), to managed clash, compliance, and other issues in premium inventory, and/or to create schedules for offline execution.

One key challenge in advertisement targeting lies in managing the wealth of data that may be used in forecasting attributes of scheduled media items. Historical data may include viewership information associated with past media item presentation collected from one or more of a variety of sources.

Another key challenge in advertisement targeting lies in the wide variety of media items. For example, when targeting advertisements for broadcast television, the same advertisement is necessarily shown to all viewers. However, when targeting advertisements for websites or streamed media items, different advertisements may be shown to different users.

Yet another key challenge in advertisement targeting lies in media item segmentation. In some contexts, such as broadcast television, advertisement opportunities (referred to herein as “advertisement inventory”) are often purchased in blocks rather than individual spots. However, inventory may be scarce relative to advertiser demand, and at the same time the advertisement service provider may need to fill the entire block, so portfolio optimization may be used to allocate advertisements. For instance, an advertisement management service provider may purchase a block of inventory (e.g., all front-page advertisement space on ESPN.com for the month of April) and then divide that inventory across different advertisers that employ the advertisement management service provider for advertisement management. Alternately, or additionally, the advertisement management service provider may work on behalf of the seller (e.g., ESPN.com) to help them allocate their block of inventory more efficiently. However, when working with individual advertisers, an advertisement management service provider may purchase specific advertisement breaks on linear television and then plan advertisements on an individual level.

According to various embodiments, techniques and mechanisms described herein provide for the determination of a media allocation plan in a way that can address one or more of these key challenges. By providing for improved media allocation, advertisements can be made more effective. In turn, users may be provided with a greater range and quantity of media content.

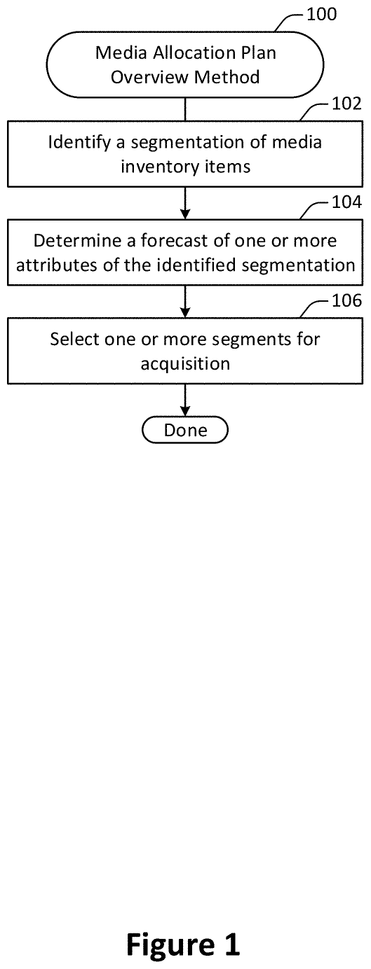

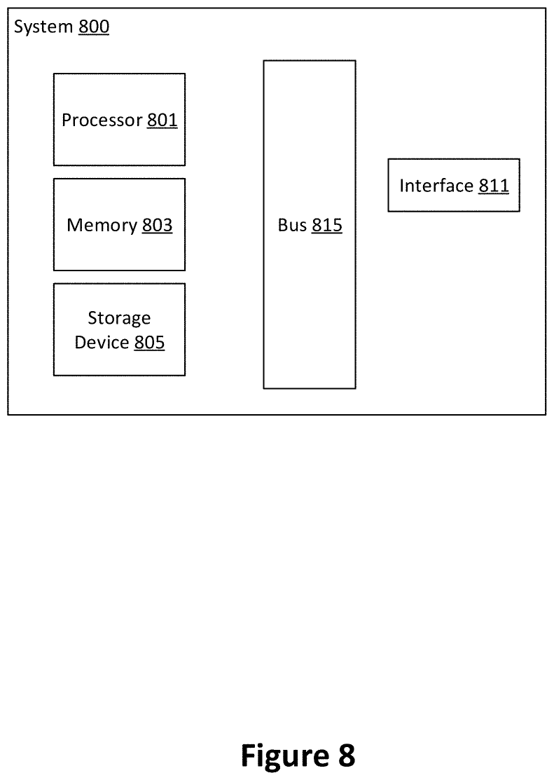

FIG. 1 illustrates an example of an overview method 100 for determining a media allocation plan, performed in accordance with one or more embodiments. According to various embodiments, the method 100 may be performed on a computing system configured to perform advertising analytics, such as the computing system 800 shown in FIG. 8.

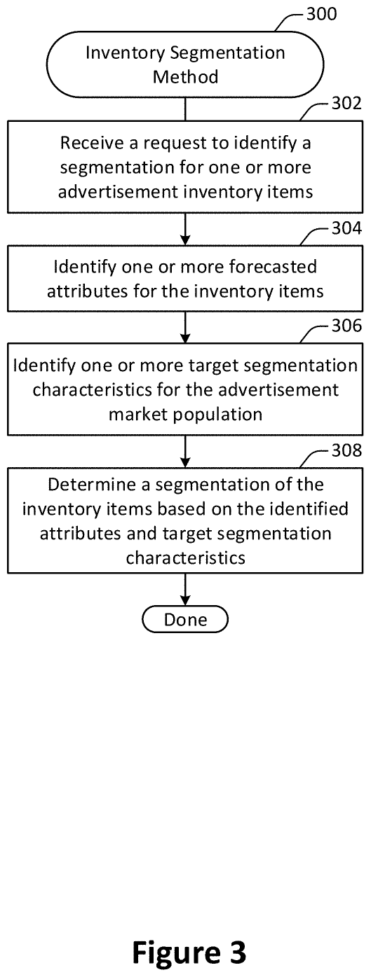

A segmentation of media inventory items is determined at 102. According to various embodiments, determining a segmentation of media items may involve operations such as determining forecasted attributes for the media inventory items, identifying target segmentation characteristics, and grouping media items together when they share relevant characteristics. Additional details related to the segmentation of media inventory items are described throughout the application, and more particularly with respect to the method 300 shown in FIG. 3.

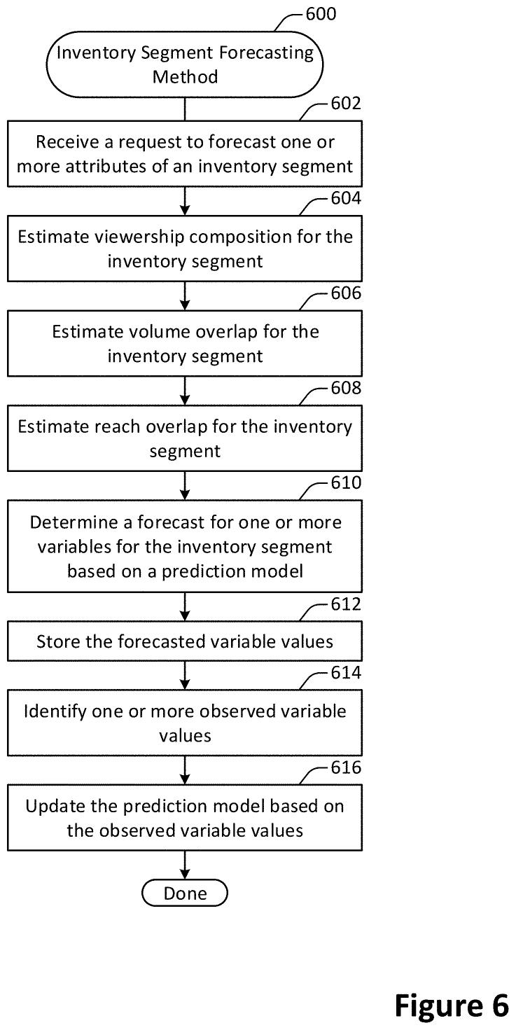

A forecast of one or more attributes of the identified segmentation is determined at 104. According to various embodiments, the forecast may predict characteristics such as media item viewer demographics, viewership numbers, and predicted outcomes and activities. Additional details related to attribute forecasting are described throughout the application, and more particularly with respect to the method 600 shown in FIG. 6.

One or more segments for acquisition are selected at 106. According to various embodiments, selecting segments for attribution may involve identifying segments associated with forecasted attributes that allow for the efficient allocation of advertisements to advertisement inventory. For example, advertisements associated with advertisers purchasing advertisement management services may be analyzed to determine whether those advertisements can be effectively and efficiently allocated to inventory within a designated segment. If so, the segment may be acquired for advertisement placement.

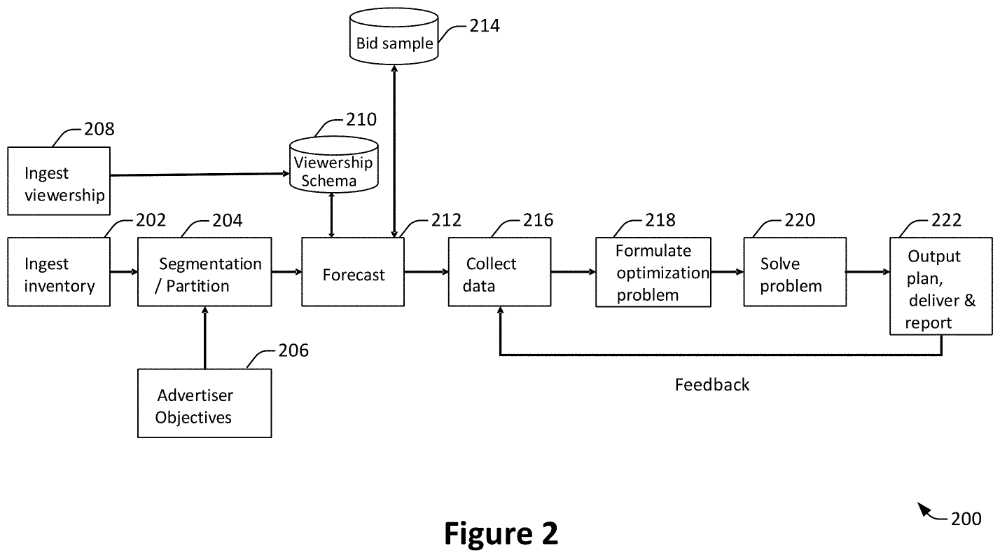

FIG. 2 illustrates an example of an arrangement of components in a demand segmentation and media allocation system 200, configured in accordance with one or more embodiments. The demand segmentation and media allocation system 200 may be used to provide advertisement placement services for potentially many different advertisers. For example, different companies may create advertisement campaigns that include advertisements to place, budgets to spend on placing the advertisements, and constraints and objectives for placing those advertisements.

Advertisement inventory is ingested at 202. According to various embodiments, the advertisement inventory may include opportunities to present advertisements in a variety of contexts. Such contexts may include, but are not limited to: broadcast television, streaming video, streaming music, podcasts, websites, video games, and physical advertisement locations. As used herein, the term “broadcast” refers to configurations in which the same program and advertisements are distributed across recipients, whereas the term “digital” refers to configurations in which different recipients may receive different programs and/or different advertisements for a particular program.

According to various embodiments, advertisement inventory may be ingested in a variety of ways. For example, media providers such as broadcast networks may transmit information about content scheduling. As another example, advertisement clearinghouses associated with websites or other advertisement venues may provide information about their content.

Advertiser objectives are identified at 206. According to various embodiments, the advertiser objectives may include any information associated with campaigns associated with advertisers placing advertisement through the service. For example, advertiser objectives may include target demographics, metrics such as completion rate, viewability rate, click through rates (CTR), budget information, or target viewership numbers. As another example, an advertiser constraint may specify that at least 25% of advertisements must be allocated to the entertainment genre. Advertiser objectives may be provided by advertisers when configuring an advertisement campaign.

Publisher objectives or restrictions may be identified instead of, or in addition to, advertiser objectives. For example, a publisher may have an objective to fill at least 80% of the available advertisement spots, or a restriction not to fill adjacent advertisement spots with the same advertiser.

Advertiser objectives may be used to segment or partition the ingested inventory at 204. Segmenting or partitioning the ingested inventory may involve, for instance, dividing the inventory into logical groupings based on factors such as predicted audience attributes. Additional details regarding inventory segmentation are discussed with respect to the method 300 shown in FIG. 3.

Viewership information about the advertisement inventory is ingested at 208. In some implementations, viewership information may include historical data that may be used to predict attributes of the inventory ingested at 202. For example, demographic information about viewers of previous presentation of a television show or television time slot may help to predict information about viewers of a television show or television time slot in the future.

According to various embodiments, viewership information may be received from one or more of a variety of data sources. After it is received, such information may be stored in a standardized viewership schema repository 210. In this way, viewership information received from different sources may be used in the same forecasting procedure.

Bid sample information is received at 214. In some embodiments, the bid sample information 214 may include historical information about bids on advertisement inventory. Such information may include, but is not limited to: inventory characteristics, bids placed, and bids won. For example, bid sample information may indicate that a bid of a designated value was placed on inventory having particular characteristic, and whether the bid was won or lost.

Attributes for the ingested and segmented inventory are forecast at 212 based at least in part on the ingested viewership information and/or the bid sample information. Any of a variety of attributes may be forecast, such as audience size, audience demographics, and metrics such as click through rate.

Based on the forecast attributes, a feedback process may be initiated in which a media allocation plan is determined. Data such as inventory segments, forecast attributes, and advertiser objectives is collected at 216. Data may also include advertiser constraints. For example, an automobile company may specify that their advertisements may not be shown in temporal proximity with another automobile company. As another example, an airline company may specify that their advertisements may not be shown in connection with a media item related to airplane crashes.

The data is then used to formulate an optimization problem at 218. In some embodiments, the optimization problem may be formulated as a mixed-integer programming (MIP) or linear programming (LP) optimization problem. MIP may refer to configurations in which some or all of the variables are constrained to be integers. In particular embodiments, MIP approaches may be more useful for broadcast configurations while LP may be more useful for digital configurations since, for example, an advertisement may be configured to reach a portion of digital subscribers but must be sent to either none or all of the broadcast subscribers.

The optimization problem is solved at 220 to produce a media allocation plan. According to various embodiments, the optimization problem may be solved with any suitable optimization problem solver. The solution to the optimization problem may be an allocation of advertisements to media inventory within media segments. For example, the solution may indicate particular media segments that, if purchased, would include advertisement inventory that could be efficiently distributed among advertisement campaigns managed through the system. For instance, the solution may include an assignment of specific advertisements to particular advertisement inventory items within segments determined at 204.

In particular embodiments, the solution to the optimization problem may be a set of allocation rules. For instance, allocation rules may be implemented as a set of weights that drive selection of advertisements among an eligible set. For example, advertisements may be randomly selected based on the weights.

The media plan is then output at 222. Data regarding the plan's performance may be provided as feedback to the data collection phase at 216 to improve the formulation of future optimization problems.

FIG. 3 illustrates an example of a method 300 for determining an inventory segmentation, performed in accordance with one or more embodiments. According to various embodiments, the method 300 may be performed in order to group together advertisement inventory items available for sale. Grouping items together simplifies prediction and allocation problems since it reduces the number of attributes to predict. Further, grouping items together reflects the fact that different audiences often tend to share similar attributes. For example, two broadcast television shows presented in temporal succession may have overlapping audiences due to people watching the same channel for a period of time.

A request to identify a segmentation for one or more advertisement inventory items is received at 302. According to various embodiments, the request may be received as part of a media allocation plan determination procedure such as the procedure 200 shown in FIG. 2. The procedure may be run periodically, at scheduled times, or upon request. For instance, the procedure may be run once per day, week, or hour.

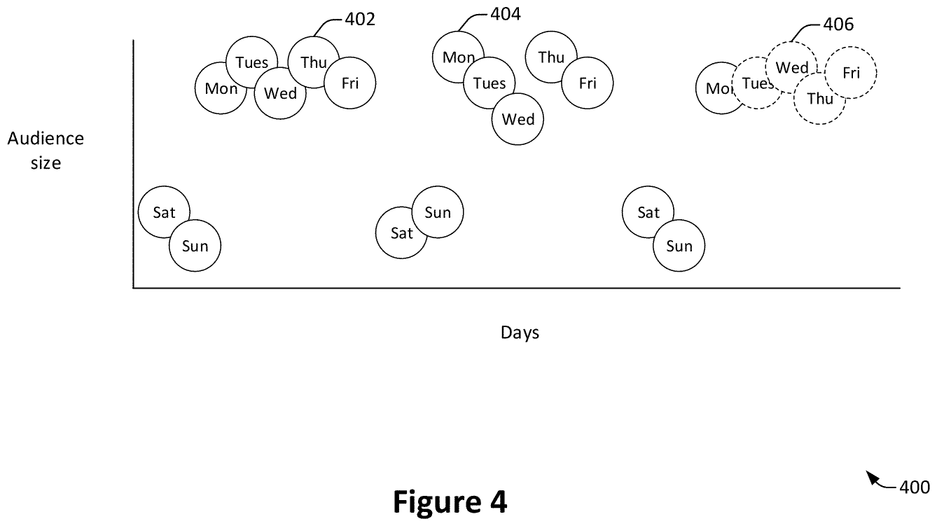

One or more forecasted attributes for the inventory items are identified at 304. According to various embodiments, identifying forecasted inventory item attributes may involve predicting individual characteristics such as audience size for the ingested inventory items. Such predictions may be performed by extrapolating from historical data using, for example, a machine learning algorithm and/or a linear or non-linear regression analysis. An example of such a prediction is shown in FIG. 4.

FIG. 4 illustrates a plot 400 generated in accordance with one or more embodiments. The plot 400 illustrates the forecasting challenge. A given inventory item such as an advertisement presented on a broadcast television channel at a designated time may be associated with historical data such as the audience size over time. For example, the audience sizes on a previous Thursday and Monday are shown at 402 and 404. Based on this historical information, and/or other relevant information, the audience size on a future day may be predicted. Moreover, audience size is only one of many possible inventory attributes that may be forecast.

Returning to FIG. 3, one or more target segmentation characteristics for the advertisement market population are identified at 306. According to various embodiments, target segmentation characteristics may reflect demographic or other characteristics that align with advertiser targeting requests. For example, many advertisers may attempt to target males that are younger than 25 years old. Accordingly, a continuous variable such as age and a discrete variable such as sex may be combined to create a binary characteristic. That is, an individual either is or is not a male younger than 25 years old.

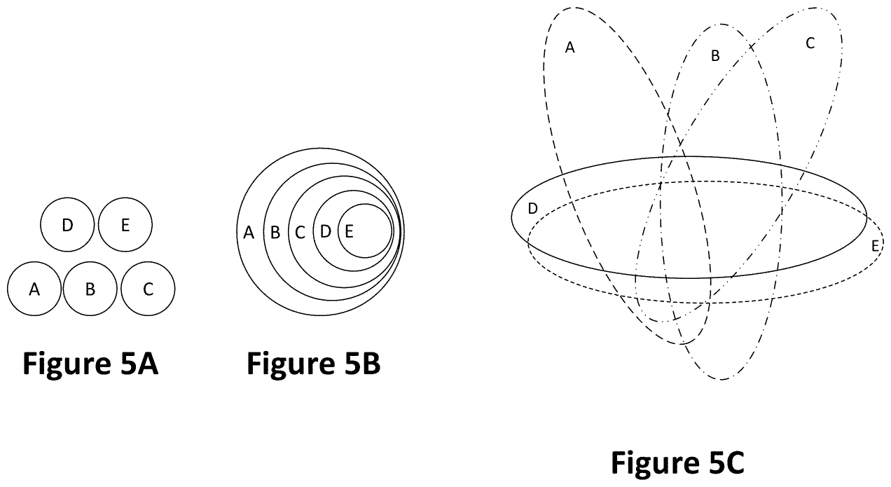

FIG. 5A, FIG. 5B, and FIG. 5C illustrate diagrams generated in accordance with one or more embodiments. FIG. 5A, FIG. 5B, and FIG. 5C help to illustrate the complexities involve in inventory attribute forecasting. Suppose for the purpose of illustration that Set A corresponds to people who live in a particular location, Set B corresponds to people within a particular age range, Set C corresponds to people within a particular income bracket, Set D corresponds to pet owners, and Set E corresponds to women. In FIG. 5A, predicting the size of these sets for a particular media inventory item in isolation involves five different isolated prediction problems. However, advertisers often wish to target individuals that have multiple attributes. With only these five attributes, predicting the size of the intersection of the sets requires solving a more complex forecasting problem in FIG. 5B. Making matters more difficult, advertisers often wish to target different sets of individuals in the alternative, such as women within a particular income bracket and geographic area, as well as men within a particular age group who are not pet owners. FIG. 5C illustrates the difficulty of forecasting the audience size when such overlapping attributes are targeted. For example, while forecasting overall audience size may be somewhat straightforward, forecasting the number of viewers who are women within a particular income bracket and geographic area is much more difficult because those sets overlap in ways that are difficult to predict and because many potential overlapping attribute sets are possible.

Returning to FIG. 3, a segmentation of the inventory items is determined at 308 based on the identified attributes and target segmentation characteristics. In some implementations, determining the segmentation of the inventory items may involve, for example, using the forecasted attributes identified at 304 to predict the target segmentation characteristics identified at 306 for different inventory items identified at 302. Then, a procedure such as a clustering algorithm may be used to group together inventory items that have similar predicted target segmentation characteristics. For example, three broadcast television shows may be grouped together into a segment because they exhibit similarly high predicted values for the demographic of males under the age of 25. As another example, five different streaming movies may be grouped together for similar reasons. Segments may also span inventory item types. For instance, a single segment may include broadcast television shows, website views, and streaming audio inventory.

In particular embodiments, the role of segmentation is to identify pockets or clusters of inventory where certain performance characteristics, such as the proportion of a particular demographic, is sufficiently different from the average (e.g., provides skew) and is available in sufficient quantity (e.g., provides scale) so that the allocation system is able to mix and match such clusters to deliver one or more desired outcomes in an efficient manner.

FIG. 6 illustrates a method 600 for media inventory forecasting, performed in accordance with one or more embodiments. In some implementations, the method 600 may be performed at a computing system configured to execute advertising campaigns on behalf of advertisers.

A request to forecast one or more attributes of a media segment is received at 602. According to various embodiments, the request may be received as part of the development of a media allocation plan, as discussed with respect to the method 100 shown in FIG. 1. One or more of a variety of variables may be forecast. Such variables may include, but are not limited to: estimated win rates and clearing prices for possible bids on advertisement placement, the size of overlap for sets of targeted audiences, the percentage of time an advertising bid request is likely to meet a set of targeting requirements, advertisement click through rate, the percentage of presented advertisements that are actually viewed, the percentage of digital video advertisements played to 100% (i.e., video completion rate (VCR)), demographic composition of a cluster of users, the number of advertising bid requests expected to be sent from a publisher to satisfy a cluster definition, and/or a set of attributes used to define a cluster of users.

Viewership composition for the media segment is estimated at 604. According to various embodiments, viewership composition may include any attributes of a target audience, such as the size of the audience. Estimating viewership composition may involve predicting future characteristics based on past characteristics. An example of such an approach is shown in FIG. 4. Based on past audience size reported for historical data, such as the audience size shown at 402 and 404, future audience size at 406 may be predicted.

Volume overlap for the media segment is estimated at 606. According to various embodiments, volume overlap for the media segment may include the number or percentage of audience members that share an attribute. Given an estimated number of users who exhibit particular characteristics, a determination may be made as to how many users are likely to share combinations of such characteristics. As shown in FIG. 5C, however, the number of possible combinations of sets explodes quickly as the number of sets increases.

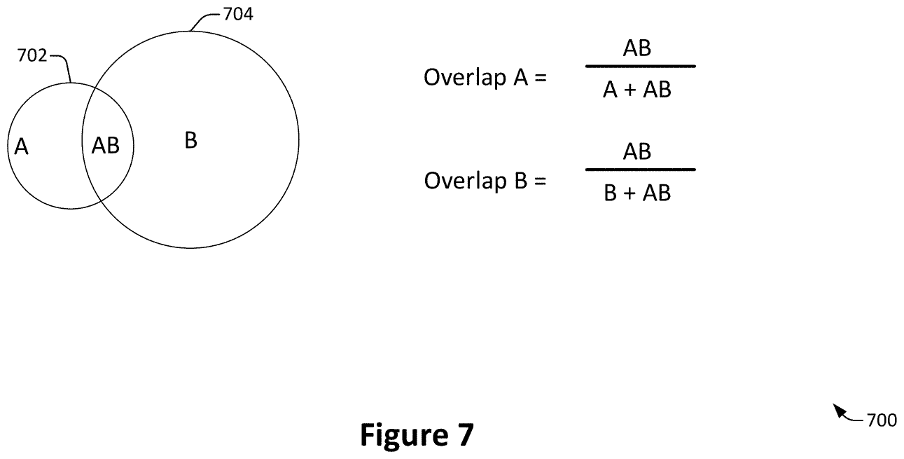

FIG. 7 illustrates a diagram 700 generated in accordance with one or more embodiments. The diagram 700 illustrates different ways in which overlap may be represented. The diagram 700 includes the set 702 and the set 704. Elements that are only members of the set 702 are labeled as A, elements that are only members of the set 704 are labeled B, and elements common to both sets are labeled AB.

In FIG. 7, the size of the set AB may be compared to either the size of A or the size of B to determine is relative magnitude. For example, the overlap of A with respect to B be may be determined by calculating the size of AB divided by the sum of the sizes of A and AB. Alternately, the overlap of B with respect to A may be calculated as the size of AB divided by the sum of the sizes of B and AB. Because the set 702 is smaller, the percentage overlap of A with respect to B is much larger than the percentage overlap of B with respect to A.

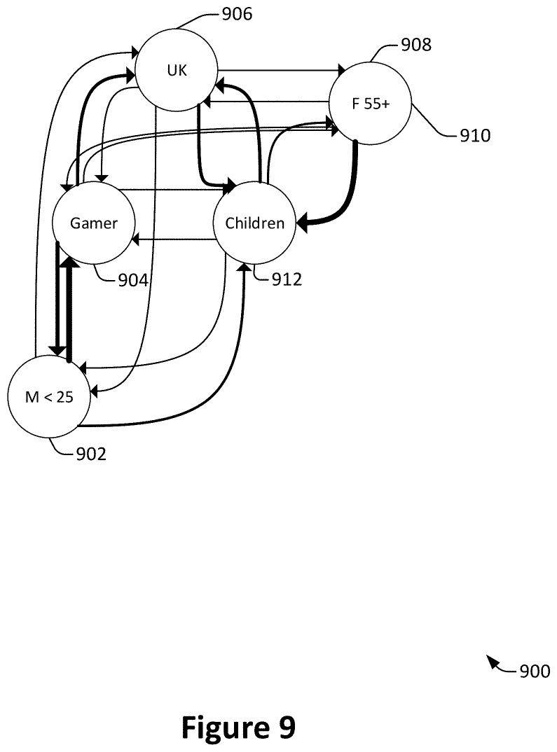

In some embodiments, a node link diagram such as that shown in FIG. 9 may be used to determine the combinations of characteristics that are most likely to lead to significant audience overlap. FIG. 9 illustrates an example of a diagram 900 generated in accordance with one or more embodiments. The diagram 900 includes a small set of possible audience attributes, including the attributes 902, 904, 906, 908, 910, and 912. In the diagram 900, arrow width represents the proportion of the individuals in a particular set that tend to be members of another set, for instance based on historical data. For example, a large proportion of males younger than 25 (902) are gamers (904). However, a smaller proportion of males younger than 25 (902) have children. These relationships need not be symmetrical. For example, a very large proportion of females older than 55 (908) may have children, while a relatively smaller proportion of people who have children may be females older than 55.

The diagram 900 illustrates how prediction models may help to forecast audience attributes. For example, an advertiser may wish to target an advertisement to gamers. Historical data may be used to identify relationships such as those shown in FIG. 9. Then, these relationships may be used to inform prediction models even where some data is lacking. For example, a prediction model may predict the number of gamers likely to appear in the audience of a media segment based in part on attributes such as the number of males under the age of 25 that are forecast for that particular media segment. Combinations of relationships may provide for even more accurate predictions. For instance, the prediction model may predict that the media segment is likely to have a large number of people with children, who are less likely to be garners, which may therefore reduce the estimate for the number of garners likely to be present in the segment.

The diagram 900 may be used to limit the number of overlapping segments that need to be determined. For example, the female 55+ segment 904 exhibits little overlap with the garner segment 904, so the overlap between those two segments may be safely ignored. However, garners 904 overlap substantially with men under the age of 25, so the overlap between those two segments may be estimated.

Reach overlap for the media segment is estimated at 608. According to various embodiments, reach overlap is the proportion of the overlapping audience that is duplicated or shared by two different reach overlap. Reach overlap is related to volume overlap via frequency. While volume overlap measures the amount of ad impression volume that is to the same people, reach overlap measures the amount of people overlap. For instance, if segments A and B had a low volume overlap but a high average frequency (i.e., the number of times the same person was counted in the segment), and segments C and D had high volume overlap but a low frequency, then it is likely that segments A and B would have a higher reach overlap than segments C and D even though the opposite is true for volume overlap.

A forecast for one or more variables is determined at 610 based on a prediction model. Weights for the prediction model may be determined by applying the model to historical training data in which outcomes are known, and then applying validation procedures such as K-fold validation to test the model's accuracy. The model may then be updated based on its subsequent performance.

The forecasted variable values are stored at 612. According to various embodiments, the forecasted variable values may be stored on a storage device, for instance for use in constructing a media allocation plan.

One or more observed variable values are identified at 614. The prediction model is then updated based on the observed variable values at 616. According to various embodiments, the observed variable values may be identified based on subsequently received data that is generated and transmitted after the advertisements associated with a segment have been presented. The observed variable values may be used to refine the prediction model.

FIG. 8 illustrates one example of a computing device. According to various embodiments, a system 800 suitable for implementing embodiments described herein includes a processor 801, a memory module 803, a storage device 805, an interface 811, and a bus 815 (e.g., a PCI bus or other interconnection fabric.) System 800 may operate as variety of devices such as an advertising analytics system, or any other device or service described herein. Although a particular configuration is described, a variety of alternative configurations are possible. The processor 801 may perform operations such as those described herein. Instructions for performing such operations may be embodied in the memory 803, on one or more non-transitory computer readable media, or on some other storage device. Various specially configured devices can also be used in place of or in addition to the processor 801. The interface 811 may be configured to send and receive data packets over a network. Examples of supported interfaces include, but are not limited to ethernet and fiber channel. These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; non-volatile memory such as flash memory or 3D XPoint memory; optical media such as compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

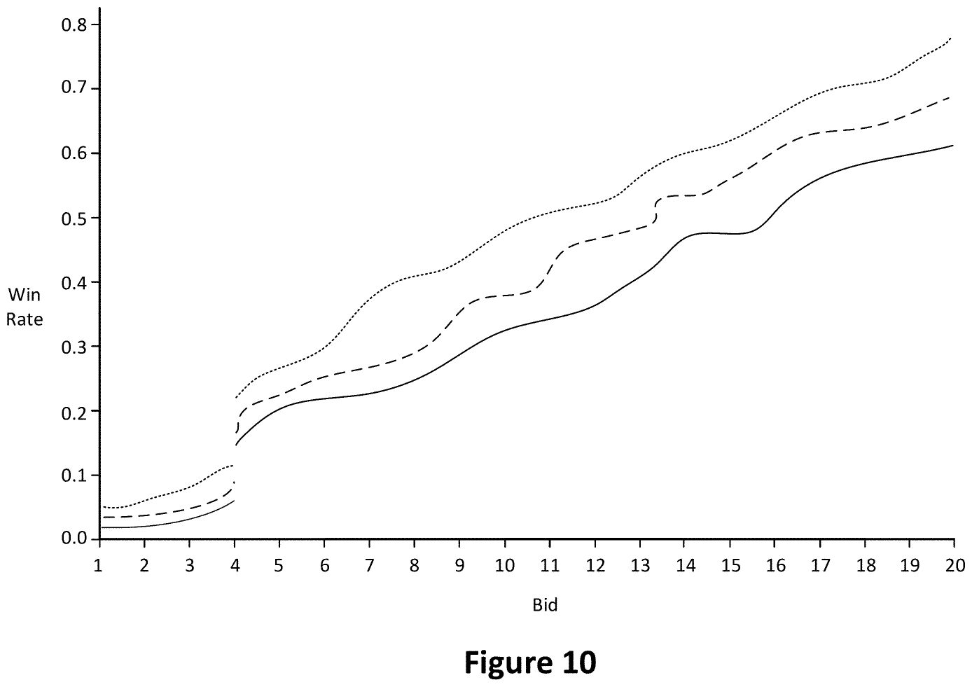

FIG. 10 illustrates a plot generated in accordance with one or more embodiments. The plot 1000 shown in FIG. 10 represents the win rate for bids as a function of bid value for different targeted populations. Different populations will have different win rates since different segments may have higher appeals. Each group may be thought of as an “audience” for which the system models the relationship between bid price and win rate. For example, an audience may be “high income person age 35-49.

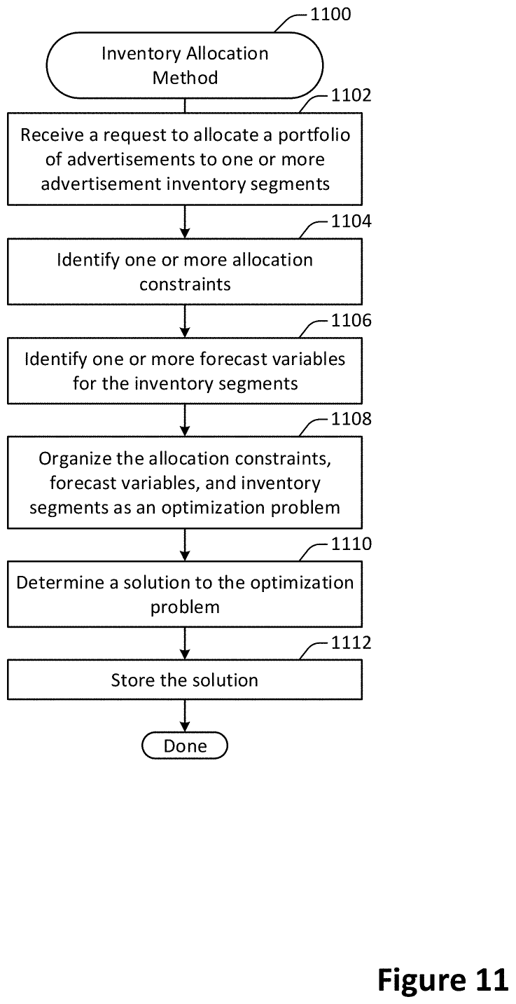

FIG. 11 illustrates an example of a method 1100 for inventory allocation, performed in accordance with one or more embodiments. The method 1100 may be performed within an advertisement placement management system, such as the system 200 shown in FIG. 2. The method 1100 may be performed periodically (e.g., weekly or daily) or upon request.

In some implementations, the method 1100 may be used to perform a variety of tasks, such as plan new advertisement campaigns in a portfolio by using slack from one or more optimization constraints to identify opportunities to employ inventory. For example, constraints may be added incrementally for a new campaign in order to quantify the impact of those constraints on the volume of advertisement inventory available to it. As another example, the method 1100 may be used to support long-term buying decisions, micro-second bid placement strategies, or anything in between, including an upfront selling strategy, an optimization process, periodic advertisement server allocation, and other such decisions.

A request to allocate a portfolio of advertisements to one or more advertisement inventory segments is received at 1102. According to various embodiments, the request may indicate one or more inventory segments determined as discussed with respect to the method 300 shown in FIG. 3, as well as characteristics forecast as discussed with respect to the method 600 shown in FIG. 6.

One or more allocation constraints are identified at 1104. According to various embodiments, the allocation constraints may involve any restrictions placed on the presentation of advertisements. For example, an airline advertiser may require that its advertisements not be presented in connection with programming in which a plane crash is depicted.

One or more forecast variables for the inventory segments are identified at 1106. According to various embodiments, the forecast variables may be determined as discussed with respect to the method 600 shown in FIG. 6.

The allocation constraints, forecast variables, and inventory segments are organized as an optimization problem at 1108. According to various embodiments, the optimization problem may be characterized as the maximization of an objective function over a solution space subject to one or more constraints.

In particular embodiments, the optimization problem may be characterized as a linear programming problem. For example, the solution space may be specified as the amount to spend on bids for a particular advertisement within a particular segment

In particular embodiments, the optimization problem may be characterized as a mixed-integer programming problem, which imposes the additional constraint that one or more of the solution variables must be an integer. For example, the solution space may be specified as a number of times an advertisement is scheduled to be presented within a particular inventory segment.

In some embodiments, the objective function may be to maximize spend on advertisements, to maximize the number of advertisements allocated, or to maximize any other suitable function. For instance, a television network may prefer to allocate inventory so as to maximize advertisement spend.

In some embodiments, the objective function may be to maximize the effectiveness of an advertisement campaign. For example, a performance metric may be specified based on any of one or more performance indicators, such as CTR.

In some embodiments, the objective function may be to minimize one or more variables subject to one or more constraints. For instance, an advertiser may want to minimize spend subject to reaching the desired audience. For instance, to reach 3 million middle-aged women, purchasing advertisements on the television show The View would be cheaper than purchasing advertisements on the Superbowl.

In some embodiments, a performance metric may be any measurable characteristic that may be included in an objective function. For example, a performance metric may be the number of people in a targeted demographic that are reached over the course of the campaign, but the full objective function may include variables such as the maximum the advertiser is willing to spend, the maximum times a single individual can view the same advertisement, and/or the minimum number of unique networks on which to present the advertisement.

In particular embodiments, an advertisement seller (e.g., a media company) may have an objective function, for instance to maximize profit, with constraints around rules and campaign performance metrics. Alternatively, or additionally, a buyer (e.g., an advertiser) may have an objective function, for instance to maximize one or more campaign performance indexes subject to constraints related to rules and/or budget. Accordingly, sellers may have an objective function focused on, for instance, maximizing margin, maximizing profit, minimize waste, and/or minimizing impressions. At the same time, buyers may have an objective function focused on campaign performance, and in particular minimizing cost, such as minimizing cost per click, maximizing demo index, maximizing reach, and/or maximizing sales.

In some embodiments, a performance metric or constraint may be specified for an advertisement seller instead of, or in addition to, a buyer. For instance, a seller might not want to air an advertisement that contrasts with its content, which may be referred to as “clash.” As an example, a soap opera television program having alcoholism as a topic may not be paired with alcohol advertisements.

In some embodiments, the allocation constraints may be used, potentially in combination with the forecast variables, to specify constraints on the solution space. For example, one allocation constraint may prevent the same advertisement to be presented within the same commercial break during broadcast television. As another example, another allocation constraint may require that a designated advertisement only be presented when inventory audience is forecasted to be primarily men under the age of 25.

A solution to the optimization problem is determined at 1110. According to various embodiments, the solution may be determined by applying any suitable optimization problem solver to the optimization problem determined at 1108. Examples of such solvers may include, but are not limited to: APOPT, ANTIGONE, Artelys Knitro, BCP, CLP, CBC, CPLEX, FortMP, Gurobi, MINOS, MOSEK, SYMPHONY, Xpress-Optimizer.

The solution is stored at 1112. According to various embodiments, the solution may be stored on any suitable local, remote, or network attached storage medium. In particular embodiments, some or all of the solution may be made available to improve future allocation and/or forecasting procedures, as discussed with respect to FIG. 2. For example, outcome information such as conversion or CTR metrics may be collected after the items included in the inventory segment have been presented. Such outcome information may then be used to adjust the allocation and/or prediction processes.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. As another example, a distributed system, a multi-core system, and/or a multi-processor system may be used. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of advertising analytics. However, the techniques of the present invention apply to a wide variety of segmentation and prediction. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A method comprising:
receiving from one or more remote computing systems via a network interface scheduling information for a plurality of scheduled media items, the scheduled media items including one or more television or radio programs, each of the scheduled media items being scheduled for presentation on a respective communication channel at a respective date and time;
determining a plurality of forecasted media item attributes, each of the forecasted media item attributes predicting an audience characteristic for a respective one or more of the plurality of scheduled media items, each of the forecasted attributes being determined based at least in part on a plurality of observed characteristics associated with previously presented media items;
identifying a division of the scheduled media items into a plurality of media segments based on the forecasted attributes, a designated one of the plurality of media segments including two or more of the scheduled media items identified based on similarities among their forecasted attributes;
determining a plurality of forecasted media segment attributes, each of the forecasted media segment attributes predicting a characteristic for a respective one of the plurality of media segments, the plurality of forecasted media segment attributes including a plurality of viewership composition values, each viewership composition value identifying a predicted audience attribute for a respective one of the plurality of media segments;
determining via a processor a media allocation plan by solving an optimization problem that includes the media segments and the forecasted media segment attributes and that is specified as a linear programming problem or a mixed-integer programming problem, the media allocation plan identifying an allocation of a plurality of advertisements to a subset of the media segments; and
storing the media allocation plan on a storage device.

2. The method recited in claim 1, wherein the optimization problem also includes one or more allocation constraints, each allocation constraint restricting the allocation of advertisements to the scheduled media items.

3. The method recited in claim 2, wherein a designated one of the allocation constraints is a time constraint, the time constraint restricting presentation of a designated advertisement based on a time of day.

4. The method recited in claim 2, wherein a designated one of the allocation constraints is a device constraint, the device constraint restricting presentation of a designated one of the advertisements based on a type of device on which the designated advertisement is presented.

5. The method recited in claim 1, wherein one or more of the forecasted attributes also correspond to a respective one or more of a plurality of advertising entities, each advertising entity corresponding to a respective one or more of the plurality of advertisements.

6. The method recited in claim 1, wherein the optimization problem is a linear programming problem.

7. The method recited in claim 1, wherein the optimization problem is a mixed-integer programming problem.

8. The method recited in claim 1, wherein the media allocation plan includes a respective media segment magnitude for each or selected ones of the subset of the media segments, the respective media segment magnitude identifying a number of advertisement opportunities associated with the respective media segment.

9. The method recited in claim 1, wherein the forecasted attributes include one or more attributes of a respective anticipated audience of the respective one or more scheduled media items.

10. The method recited in claim 1, wherein the forecasted attributes include one or more attributes of devices on which the scheduled media items are anticipated to be accessed.

11. The method recited in claim 1, wherein the forecasted attributes include one or more attributes of web pages on which the scheduled media items are anticipated to be accessed.

12. A computing system comprising:
a communication interface operable to receive from one or more remote computing systems via a network interface scheduling information for a plurality of scheduled media items, the scheduled media items including one or more television or radio programs, each of the scheduled media items being scheduled for presentation on a respective communication channel at a respective date and time;
a processor operable to:
determine a plurality of forecasted media item attributes, each of the forecasted media item attributes predicting an audience characteristic for a respective one or more of the plurality of scheduled media items, each of the forecasted attributes being determined based at least in part on a plurality of observed characteristics associated with previously presented media items;
identify a division of the scheduled media items into a plurality of media segments based on the forecasted attributes, a designated one of the plurality of media segments including two or more of the scheduled media items identified based on similarities among their forecasted attributes;
determine a plurality of forecasted media segment attributes, each of the forecasted media segment attributes predicting a characteristic for a respective one of the plurality of media segments, the plurality of forecasted media segment attributes including a plurality of viewership composition values, each viewership composition value identifying a predicted audience attribute for a respective one of the plurality of media segments;
determine via a processor a media allocation plan by solving an optimization problem that includes the media segments and the forecasted media segment attributes and that is specified as a linear programming problem or a mixed-integer programming problem, the media allocation plan identifying an allocation of a plurality of advertisements to a subset of the media segments; and
a storage system operable to store the media allocation plan.

13. The computing system recited in claim 12, wherein the optimization problem also includes one or more allocation constraints, each allocation constraint restricting the allocation of advertisements to the scheduled media items.

14. The computing system recited in claim 13, wherein a designated one of the allocation constraints is a time constraint, the time constraint restricting presentation of a designated advertisement based on a time of day.

15. The computing system recited in claim 13, wherein a designated one of the allocation constraints is a device constraint, the device constraint restricting presentation of a designated one of the advertisements based on a type of device on which the designated advertisement is presented.

16. The computing system recited in claim 12, wherein one or more of the forecasted attributes also correspond to a respective one or more of a plurality of advertising entities, each advertising entity corresponding to a respective one or more of the plurality of advertisements.

17. One or more non-transitory computer readable media having instructions stored thereon for performing a method, the method comprising:
receiving from one or more remote computing systems via a network interface scheduling information for a plurality of scheduled media items, the scheduled media items including one or more television or radio programs, each of the scheduled media items being scheduled for presentation on a respective communication channel at a respective date and time;
determining a plurality of forecasted media item attributes, each of the forecasted media item attributes predicting an audience characteristic for a respective one or more of the plurality of scheduled media items, each of the forecasted attributes being determined based at least in part on a plurality of observed characteristics associated with previously presented media items;
identifying a division of the scheduled media items into a plurality of media segments based on the forecasted attributes, a designated one of the plurality of media segments including two or more of the scheduled media items identified based on similarities among their forecasted attributes;
determining a plurality of forecasted media segment attributes, each of the forecasted media segment attributes predicting a characteristic for a respective one of the plurality of media segments, the plurality of forecasted media segment attributes including a plurality of viewership composition values, each viewership composition value identifying a predicted audience attribute for a respective one of the plurality of media segments;
determining via a processor a media allocation plan by solving an optimization problem that includes the media segments and the forecasted media segment attributes and that is specified as a linear programming problem or a mixed-integer programming problem, the media allocation plan identifying an allocation of a plurality of advertisements to a subset of the media segments; and
storing the media allocation plan on a storage device.

18. The one or more non-transitory computer readable media recited in claim 17, wherein the optimization problem also includes one or more allocation constraints, each allocation constraint restricting the allocation of advertisements to the scheduled media items.

19. The one or more non-transitory computer readable media recited in claim 18, wherein a designated one of the allocation constraints is a time constraint, the time constraint restricting presentation of a designated advertisement based on a time of day.

20. The one or more non-transitory computer readable media recited in claim 18, wherein a designated one of the allocation constraints is a device constraint, the device constraint restricting presentation of a designated one of the advertisements based on a type of device on which the designated advertisement is presented.
